(19) United States
(12) Patent Application Publication
(10) Pub. No.: US 2006/0177789 A1
(43) Pub. Date: Aug. 10, 2006

(54) Orthodontic system

(76) Inventor: Robert O'Bryan, Corona del Mar, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/071,876

(22) Filed: Mar. 3, 2005

Related U.S. Application Data
(60) Provisional application No. 60/649,899, filed on Feb. 4, 2005.

(51) Int. Cl. A61C 3/00

(52) U.S. Cl. 433/6; 433/18

(57) ABSTRACT

Described herein is an orthodontic system, including an appliance configured to cover substantially at least two adjacent teeth in a person's mouth, the appliance including a wedge configured to contact a first surface of a tooth and exert a force on the tooth in a direction. The appliance, when positioned in the mouth, defines a first bounding surface of a movement volume into which the first tooth is permitted to move substantially in response to the force. A second surface of the first tooth defines a second bounding surface of the movement volume, when the appliance is positioned in the mouth.

### RELATED APPLICATION INFORMATION

This application claims priority under 35 U.S.C. § 119(e) to U.S. Provisional Application Ser. No. 60/649,899, filed Feb. 4, 2005, the entirety of which is hereby incorporated by reference.

### BACKGROUND OF THE INVENTION

### Field of the Invention

This disclosure relates generally to orthodontics and more specifically to the cosmetic movement of teeth.

Physical Health Considerations

Numerous health risks are associated with not having perfectly straight and aligned teeth, and with imperfect bite (malocclusion). One malady caused by malocclusion is the gradual loosening of a patient's teeth from the bone and gums that results from the continual rubbing of one tooth against another. If the malocclusion is severe enough, then misalignment of the jaws (traumatic occlusion) is an additional, significant health risk.

When a tooth is misaligned it will often abrade other teeth. The additional friction of misaligned teeth continually rubbing against each other can erode the tooth's protective enamel layer. The loss of the protective enamel layer makes the tooth more susceptible to other problems, such as potentially irreversible decay.

Recent studies indicate that anaerobic bacteria from periodontal disease play a role in other, less apparent, health matters. The presence of bacteria in a person's blood, known as “septicemia,” may be caused by entry of the bacteria from the periodontium and can cause infection of heart valves (infective endocarditis) that may lead to heart attack, congestive heart failure, and stroke. The anaerobic bacteria associated with periodontal disease have also been located in the lungs and the respiratory system, and contribute to some types of pneumonia. These discoveries and studies further implicate the importance of proper dental health.

Mental Health Considerations

In addition to the physical health-care benefits of having properly aligned and well maintained teeth and gums, social and psychological benefits accrue to persons who have an attractive smile. People who have required dramatic tooth movement to create a nice smile line experience positive and profound changes in their attitude and mood once the treatment is completed and their visible teeth are in their targeted and correct positions. It is almost intuitive that there will be an associated increase in people's mental health when they feel more confident about their appearance. People are much happier and more outgoing after treatment is completed, particularly those who are treated for more serious dental problems in their smile line.

Orthodontic and Cosmetic Tooth Movement

There are a number of different ways that a tooth could be misaligned or out of position. First, a tooth can be angled such that the large, substantially planar surface of the tooth is set at an angle to the ideal plane (tipped). Second, a tooth can be rotated about its approximately long vertical axis (rotated). Third, a tooth can be rotated about its approximately long horizontal axis such that the root is tipped to the buccal or lingual aspect in the bone (inclined). Fourth, a tooth can be rotated about its short approximately horizontal axis such that the root is angled toward the front or back of the jaw (angulated). Fifth, a tooth can be positioned too far into the bone or partially erupted out of correct position correct position (intruded), or the tooth can also be positioned too far in the direction of eruption (extruded). Sixth, an entire tooth, including the root, can be positioned too far in the buccal or lingual direction (translated).

Misaligned or out-of-position teeth can require first degree movement, second degree movement, or a combination of the two. First degree movement does not require the root of the tooth to move in the jawbone. Tipping a tooth is an example of first degree tooth movement. When one corrects the position of a tipped tooth, the pivot point (or fulcrum) for the desired motion is the root of the tooth within the jawbone. Therefore, because the root of the tooth is stationary, it is fairly easy for dental health care professionals to correct tipped teeth.

Many of the other types of tooth movement, on the other hand, are examples of second degree tooth movement. In second degree movement, the root physically moves through the bone of the jaw; that is, root of the tooth moves through the bone as opposed to rocking in the bone as with tipping. The fulcrum of the motion in these cases generally is not the root of the tooth.

If the dental health care professional attempted to correct the position of a tooth (or the appearance of a tooth) utilizing first degree movement (e.g. tipping) alone, then the tooth face would ostensibly be in its correct position, but the root of the tooth would remain in an incorrect position. When the root of the tooth is in the wrong position there is an increased risk of health problems, and a significant chance for relapse. Moving the root of a tooth into its correct position is better for the health of the tooth, better for the health of the jawbone, and it makes the final (correct) position of the tooth more stable.

Another problem that dental health care providers are faced with is intermittent or deteriorating patient compliance with treatment orders. On average, patients are compliant with dental-care instructions for about six months. After the six-month period, patient compliance—such as in using dental appliances on schedule—is significantly reduced. Reduced compliance can cause the patient's teeth to relapse to their unhealthy and undesired position. Moreover, if a patient's teeth relapse, the patient will be disappointed. This can reduce compliance even further and lead to increased health risks.

Patients who simply want to make minor cosmetic improvements to their smile line face numerous barriers including degree, duration, and frequency of treatment. Cosmetic tooth movement typically focuses on the positioning of the top eight and bottom eight teeth most likely to be visible when smiling. Adults, for the most part, are comfortable with the way their molars interact, and they have little inclination to try to change their bite in that respect. As discussed above, the treatment duration should be as short as possible to achieve the best results. As such there is a need for a method and apparatus to promote cosmetic tooth movement that will, in a short period of time, improve the patient's smile without impairing the patient's bite.

Description of the Related Art

Bracket and Band Braces

Traditionally, dental health care professionals have sought to prevent problems associated with misaligned teeth, and to provide cosmetic improvement to the smile line, by using bracket and band braces. The conventional bracket and band braces are typically made of metal, and they utilize brackets, bands and wires to apply force to the teeth in order to promote first and second degree movement.

Moving misaligned teeth in the bracket and band method is usually accomplished using metallic brackets, bands and wires. The metallic brackets and bands are typically attached to the buccal surface of the patient's teeth. In some cases (and at greater expense) the brackets and bands can be attached to the lingual surface of the patient's teeth. Generally, brackets are attached to the front teeth and bands are attached to the molars. The brackets contain grooves or slots which are used to position and maintain the wires. The wires are affixed to the brackets and span the upper and lower teeth. The wires (not the brackets and bands) apply the force necessary to promote movement of the teeth from their misaligned positions into their correct positions.

Also, when the bracket and band braces are removed, the teeth are mobile and not in correct position. After the braces are removed, the patient must wear an appliance (such as a retainer, positioner or corrective appliance) to move the teeth in their correct position until the teeth become fixed in their final positions. This further extends the duration of treatment in the bracket and brace model.

Another downside of bracket and band braces is that patients often evidence increased tooth decay around the sites of the brackets. This is because the brackets are more difficult to clean, relative to unencumbered teeth, and the cleaning process takes longer than simply brushing and flossing. The combination of the increased level of difficulty and patient non-compliance with the recommended cleaning process can result in increased tooth decay.

Finally, the bracket and band method is not well-suited for patients who simply want to make minor cosmetic improvements to their smile line. Cosmetic tooth movement typically focuses on the positioning of the top eight and bottom eight teeth most likely to be visible when smiling. Adults, for the most part, are comfortable with the way their molars interact, and they have little inclination to try to change their bite in that respect. As discussed above, the treatment duration should be as short as possible to achieve the best results. And it is also more difficult for adults, logistically, to schedule multiple appointments with the dental health care professional for status checks, adjustments, and conferences for extended treatment periods. As such there is a need for a method and apparatus that will promote cosmetic tooth movement that will, in a short period of time, improve the patient's smile line without altering the patient's bite.

### SUMMARY OF THE INVENTION

A method and apparatus for promoting cosmetic tooth movement that is capable of being performed by a general practitioner, rather than an orthodontic specialist, is also desirable. In such a case, the cosmetic tooth movement can be combined with other forms of general dentistry such as minor tooth repair, bonding, cleaning, whitening and gum tissue health care. This is desirable for the patient because it enables a single, dental health care professional to move the targeted teeth, complete minor tooth repair, and clean the patient's teeth. As such, the patient experiences a reduction in the number of dental appointments, dental care costs, and inconvenience. Similarly, a shorter duration of treatment, taken together with fewer patient visits, enables dental health care professionals to treat more patients.

There has been a long felt need in the dental health care community for an apparatus and method to move misaligned teeth into their correct positions by applying a measured and geometrically precise force to the targeted teeth. There has been a long felt need in the dental health care community to promote universal dental health and stimulate patient compliance through an apparatus and method that is inexpensive, reduces treatment time, and does not require time consuming and unduly repetitive oversight from the dental health care professional.

There has been a long-felt need in the dental health care community for an apparatus and method capable of moving misaligned teeth into their correct positions by applying a measured and geometrically precise force to the targeted teeth. There has been a long felt need in the dental health care community for a method and apparatus capable of promoting second degree movement of misaligned teeth using a single appliance. There has been a long felt need in the dental health care community to promote universal dental health and stimulate patient compliance through an apparatus and method that is both inexpensive and does not require unduly repetitive oversight from the dental health care professional over and extended treatment period.

The method and apparatus of the present invention can lower the cost to the patient to achieve specific orthodontic results. In many cases, the techniques and apparatus disclosed herein can achieve the desired cosmetic or orthodontic result in a matter of months as opposed to years. In some cases, the techniques disclosed herein can achieve the desired results in as little as about 90 days. This is to be compared with traditional methods of orthodontics and cosmetic adjustment of teeth that can take on the order of years to achieve the desired result. The abbreviated treatment period can lower the net cost to the patient by reducing the number of occasions that it is necessary to confer with the dental health care professional. Fewer visits to the dentist or orthodontist can reduce the patient's overall cost in achieving the desired result.

One aspect of the present invention is an altered model of a patient's teeth comprising one or a plurality of supplemental blanks. In some embodiments, a supplemental blank substantially occupies the targeted final position of a misaligned tooth. In other embodiments, a supplemental blank substantially occupies the region between the actual and targeted position of the tooth.

Another aspect of the present invention is an altered model of a patient's teeth comprising one or a plurality of recesses. In some embodiments, a recess can be carved into a tooth in a model. In some embodiments, the dimensions of the recess can correlate to the degree of force useful to promote movement of a tooth into its desired position.

Another aspect of the present invention is an aligner and Variable Depth Technology Wedge apparatus to promote orthodontic and cosmetic movement of misaligned teeth. In some embodiments the aligner and Variable Depth Technology Wedge apparatus is a single, integrated unit.

Another aspect of the present invention is an aligner and Variable Depth Technology Wedge apparatus comprising a movement volume. In some embodiments, a movement volume correlates with a volume occupied by a supplemental blank in an altered model of the patient's teeth. In some embodiments, the shape of a Variable Depth Technology Wedge correlates to the shape of a recess in a model of a patient's teeth.

Another aspect of the present invention is a Contour Attachment. In some embodiments, a Contour Attachment is affixed to the surface of a tooth targeted for movement. In some embodiments, a Contour Attachment is formed into a substantially polygonal shape. In some embodiments, the Contour Attachment has a non-uniform thickness. In some embodiments a Contour Attachment is shaped to substantially interact with a Variable Depth Technology Wedge. In some embodiments, a Contour Attachment is shaped to be a substantial counterpart to a Variable Depth Technology Wedge. In some embodiments, a Contour Attachment communicates with a Variable Depth Technology Wedge to promote both first and second degree movement of a tooth.

Another aspect of the present invention is a method to promote movement of misaligned teeth. In some embodiments, the method promotes first degree movement of a tooth or teeth. In some embodiments, the method promotes second degree movement of a tooth or teeth. In some embodiments, the method promotes first and second degree movement of a tooth or teeth. In some embodiments, the method utilizes a single appliance for the duration of the treatment. In other embodiments, the method utilizes a single, adaptable appliance for the duration of the treatment. In some embodiments, the method utilizes a repeatedly adapted appliance over the period of treatment. In some methods, the treatment can be completed in less than about six months. In other embodiments, the treatment can be completed in less than about 90 days.

One embodiment of the present invention is an orthodontic system, comprising a body configured to cover substantially at least two adjacent teeth in a person's mouth; the body comprising a wedge configured to contact a first surface of a first tooth of the at least two teeth and exert a force on the first tooth in a first direction; wherein the body, when positioned in the mouth, defines a first bounding surface of a movement volume into which the first tooth is permitted to move substantially in the first direction in response to the force; and wherein a second surface of the first tooth defines a second bounding surface of the movement volume, when the body is positioned in the mouth.

Another embodiment of the invention is the orthodontic system, wherein the first surface of the first tooth is opposite the second surface of the first tooth.

Another embodiment of the invention is the orthodontic system further comprising a contour attachment configured to attach to the first surface of the first tooth and contact the wedge.

Another embodiment of the invention is the orthodontic system, wherein the contour attachment engages the wedge to promote or alter at least one of rotation, angulation, intrusion, extrusion, translation, inclination, and tipping of the first tooth.

Another embodiment of the invention is the orthodontic system, wherein the first and second surfaces of the first tooth are substantially the same surface.

Another embodiment of the invention is an orthodontic system, comprising a body configured to cover substantially at least two adjacent teeth in a person's mouth; a contour attachment configured to (1) be attached to a first surface of a first tooth of the at least two teeth, and (2) contact a surface of the body; wherein the body, when positioned in the mouth, defines a first bounding surface of a movement volume into which the first tooth is permitted to move in response to a force transmitted from the body through the contour attachment; and; wherein a second surface of the first tooth defines a second bounding surface of the movement volume, when the body is positioned in the mouth.

Another embodiment of the invention is the orthodontic system of claim 6, wherein the body further comprises a wedge that transmits the force to the first tooth through the contour attachment; and wherein a surface of the wedge comprises the surface of the body.

Another embodiment of the invention is the orthodontic system described above, wherein the wedge is attachable to a remainder of the body.

Another embodiment of the invention is the orthodontic system wherein the contour attachment engages the wedge to promote or alter at least one of rotation, angulation, intrusion, extrusion, translation, inclination, and tipping of the first tooth.

Another embodiment of the invention is an orthodontic system comprising a body configured to cover substantially at least two adjacent teeth in a person's mouth; a contour attachment configured to be attached to a surface of a first tooth of the at least two teeth; and; wherein the body comprises a wedge configured to contact the contour attachment and exert a force on the first tooth through the contour attachment when the body is positioned in the mouth.

Another embodiment of the invention is the orthodontic system described above wherein the contour attachment engages the wedge to promote or alter at least one of rotation, angulation, intrusion, extrusion, translation, inclination, and tipping of said first tooth.

Some embodiments of the invention include methods of moving teeth by positioning any of the orthodontic appliances described herein in a patient's mouth.

### BRIEF DESCRIPTION OF THE DRAWINGS

FIG. 1 is a photograph of an unaltered, three-dimensional model of a patient's teeth. This model is a model of a patient's upper arch. The model is made of dental stone.

FIG. 2 is a photograph of an altered model of a patient's teeth. The dark regions on the lingual aspect of the left central and lateral incisor and the buccal aspect of the left lateral incisor are supplemental blanks corresponding in whole or in part to the desired final position of the targeted teeth. In this altered model, the supplemental blanks comprise block-out resin.

FIG. 3 shows an aligner and Variable Depth Technology Wedge as an integrated, single object.

FIG. 4 is a photograph of an altered model of a patient's teeth. The dark regions are supplemental blanks. Also shown are recesses carved into the buccal side the left central incisor, lateral incisor, and canine. The depth of the recesses at various points correlates to the force that will be applied at those points. The recess in the front is substantially approximately triangular at the surface and substantially approximately pyramidal over its volume. If an aligner is made from this altered model, the aligner will comprise Variable Depth Technology Wedges with shapes corresponding to the shapes of the recesses.

FIG. 5 shows an example of a Contour Attachment affixed to a thumbnail. In this example, the Contour Attachment comprises a single ridge of material. In this example, the Contour Attachment is substantially circular or substantially bagel shaped. In this example, the contour attachment is substantially free of material in its bounded region.

FIG. 6 shows an example of a Contour Attachment attached to a model to show what a Contour Attachment might look like on an actual tooth. In this example, the Contour Attachment is of non-uniform thickness. The perimeter of the Contour Attachment is thicker and the interior, bounded region is thinner. In practice, the Contour Attachment is affixed to the patient's actual tooth and not the model of the patient's tooth

FIG. 7a through 7i show examples of some embodiments of the invention, such as an aligner and Variable Depth Technology wedge, a supplemental blank, a recess, a movement volume, and a Contour Attachment.

FIG. 8 is a photograph of another altered model of a patient's teeth. It is similar to FIG. 4. This figure shows recesses on the buccal side of a plurality of targeted teeth. The depth of the recesses at various points correlates to the force that will be applied at those points. The recesses are substantially approximately triangular at the surfaces of the teeth and substantially approximately pyramidal over the volume. If an aligner is made from this altered model, the aligner will comprise Variable Depth Technology Wedges with shapes corresponding to the shapes of the recesses.

FIG. 9 is a photograph of an unaltered model of a patient's upper arch. The model is made of dental stone.

FIG. 10 is a photograph of another altered model of a patient's teeth. The dark regions on the left central incisor and right lateral incisor are supplemental blanks which correspond, in whole or in part, to the desired final position of the targeted teeth.

### DETAILED DESCRIPTION OF THE PREFERRED EMBODIMENT

The method and apparatus of the present invention can lower the cost to the patient to achieve specific orthodontic results. In many cases, the techniques and apparatus disclosed herein can achieve the desired cosmetic or orthodontic result in a matter of months. In most cases, the techniques and apparatus disclosed herein can be able to achieve the desired orthodontic and/or cosmetic results in as little as 90 days. Traditional methods of orthodontics and cosmetic adjustment of teeth typically take eighteen months or more to achieve the desired result. An abbreviated treatment period associated with the method and apparatus disclosed herein can lower the net cost to the patient by reducing the number of occasions that it is necessary to confer with the dental health care professional. Fewer visits to the dentist or orthodontist can reduce the patient's overall cost in achieving the desired result.

The method and apparatus disclosed herein is also more convenient for the patient than bracket and band or other methods of moving teeth. Because the present invention can take less time to achieve the desired result, there is a decrease in dental appointments. From the patient's point of view, fewer dental appointments can mean fewer scheduling difficulties and more time for other activities. From the dental health care professional's point of view, fewer appointments per patient can mean that more patients can be treated in the same amount of time.

The Model

One aspect of the apparatus and method for the present invention is a model of the patient's upper and lower teeth. The model of the patient's teeth can be constructed using methods and techniques known to those of ordinary skill in the art. One method that can be used to construct the model of the patient's teeth is to first take impressions of the patient's upper and lower arches using a compound, preferably a poly-vinyl material such as polyvinyl siloxane, that will conform to the shape of the patient's teeth. Once completed, the impressions can be used to cast a three dimensional model of the patient's upper and lower teeth.

Preferably, the three-dimensional models are custom made by a commercial laboratory that specializes in manufacturing models for dental health care professionals. More preferably, the three-dimensional models of patients' teeth are made in-house by the dental health care professional.

One of ordinary skill in the art will recognize that the three-dimensional models of the patient's teeth can be made from any one or a combination of a number of materials known in the art. The upper and lower models of the patient's teeth can be constructed from materials such as dental stone, porcelain, plastic, clay, metal, or any other suitable material. Preferably, the models are constructed of a material that is rigid but that can be easily carved, cut, or altered. Preferably, the model is made of dental stone.

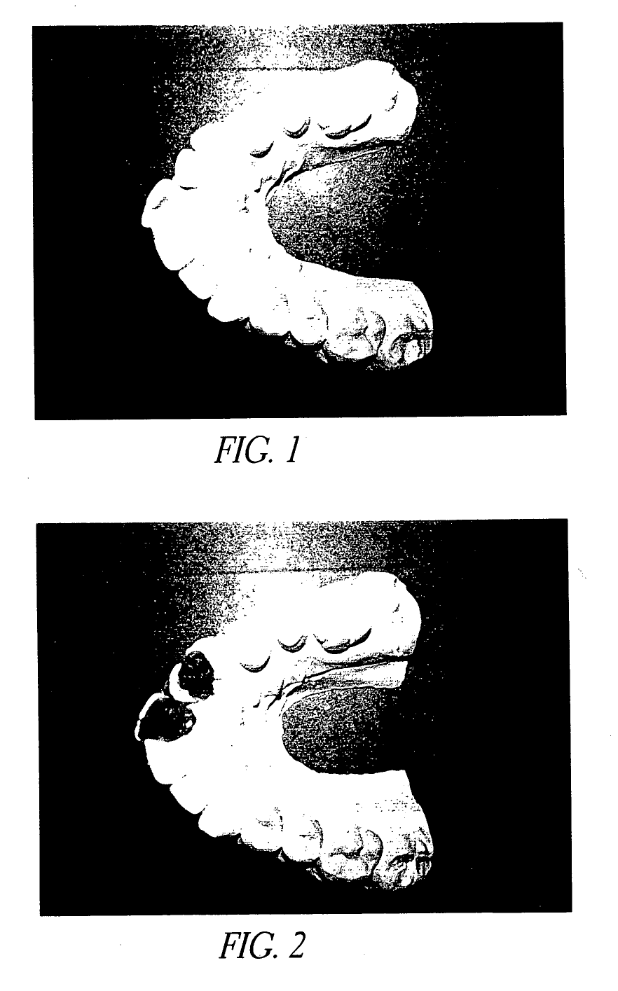

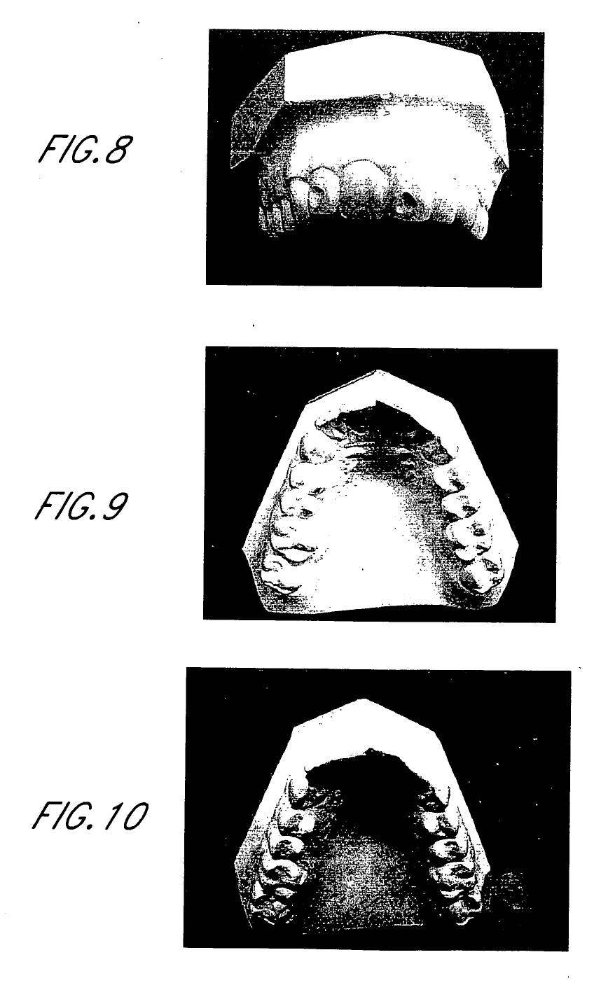

As described above, the dental healthcare professional can first create a female impression of the patient's teeth. The dental health care professional or third party can then create the male impression of the patient's teeth using a material such as dental stone. For example, both FIG. 1 and FIG. 9 show examples of three-dimensional, dental stone models of patients' upper arches.

A dental health care professional can then create the desired final position for the patient's teeth by altering the three dimensional model and/or inserting “supplemental blanks.” The supplemental blanks can be designed such that, when they are affixed to the three-dimensional model of the patient's teeth, they can occupy the volume of the desired final position for: a portion of one targeted tooth, a portion of a plurality of targeted teeth, or the entire desired final position of one targeted tooth, or the entire desired final position of a plurality of targeted teeth, or any combination thereof. The supplemental blank can also be designed such that, when it is affixed to the three-dimensional model of the patient's teeth, it can occupy the volumes described above plus the volume between the misaligned position and the final desired position of the targeted tooth, teeth or portions thereof.

Preferably, the consistency of any materials used to create the supplemental blank is such that it is easily molded by the dental health care professional. More preferably, the easily moldable material will harden over time, or can be encouraged to harden using some other quantity, including but not limited to, heat, light, hardener or hardening coating. The dental health care professional can create the desired final position for the targeted teeth using a variety of materials, including but not limited to, wax, clay, or resin. The supplemental blank can be constructed of any other suitable material that is known to one of skill in the art.

Preferably, the material used to create the desired final position of the targeted teeth is “block-out resin”. Block-out resin is a generic name for a substance that is made by numerous manufacturers. Block-out resin is initially in a semi-solid phase. In this phase, the dental health care professional can mold the resin and affix it to, or place it in communication with, the model of the patient's teeth at the desired final position.

Preferably, the block-out resin is light activated. More preferably, the block-out resin is hardened by visible light. When the block-out resin is properly positioned in the model, it can be hardened by exposing it to light. Typically, the light used to harden the resin is generated by standard dental appliances.

If the dental health care professional uses a supplemental blank with the three-dimensional model, any appliance created using the altered model as a mold will exhibit a movement volume where the supplemental blank or blanks resided. This corresponds to a movement volume in the appliance that is the desired final position for the targeted tooth. That is, the volume occupied by the supplemental blank creates space in the appliance for the desired tooth movement. The space occupied by the supplemental blank in the three-dimensional model of the patient's teeth is the correct position for the tooth targeted for movement. In a case where a tooth needs to be rotated, supplemental blanks can be affixed to portions of both sides of the tooth. This can be desirable because it can be necessary to rotate the tooth around a vertical axis. Therefore it can be desirable to create movement volumes in the appliance on both sides of the tooth.

An advantage of using the supplemental blanks to create movement volume in the appliance is that the length of time needed to promote the desired movement will be reduced. This is because there is no resistance to the movement of the tooth caused by portions of the appliance occupying the volume into which the tooth is targeted to move. Consequently, the net force on the tooth in the desired direction is increased, and the rapidity of motion is increased.

FIG. 2 shows the three dimensional model of the patient in FIG. 1 with the added feature of supplemental blanks. The dark-colored areas correspond to the supplemental blanks constructed of, in this case, hardened block-out resin. The supplemental blanks indicate the desired movements and final positions for the teeth.

The Aligner

Another aspect of the present invention is the Aligner. The aligner is the appliance that the patient inserts into the mouth in order to promote orthodontic or cosmetic movement of the teeth. The aligner is preferably cast from the model of the patient's teeth. Preferably, the model is altered prior to casting the aligner from the model. More preferably, the aligner is cast from an altered model of the patient's teeth such that the aligner alone or with a plurality of Variable Depth Technology Wedges (discussed below) is of single-cast construction.

The aligner can comprise plastic, metal, ceramic, porcelain, wood, or any suitable material known in the art. Preferably the aligner is constructed of medical grade thermoplastic. More preferably the aligner comprises transparent medical grade thermoplastic. Still more preferably, the aligner construction is strong enough to prevent deformation of its structure as a result of the force exerted on it when positioned over the patient's teeth. More preferably, the aligner is constructed of 0.040 (1 mm thick) transparent, medical grade thermoplastic. Preferably, the aligner is formed on a vacu-form machine by shrink-wrapping thermoplastic sheeting over the altered model of the patient's teeth. Once the sheeting has formed over the models, the aligner can be cut out. The first cut, (a rough preliminary cut) can be done by trimming the plastic with the circular blade of an electric hand piece. The aligner can then be removed from the model. It can be finely tuned to fit the patient by trimming with a small curved scissor and then can be polished with a buffer on the electric hand piece.

The Variable Depth Technology Wedge

A variable depth technology wedge is a physical object that can exert force on a targeted tooth to promote movement of the tooth to its desired final position. A variable depth technology wedge is capable of exerting measured force on the tooth to achieve movement including, but not limited to, tip, rotation, intrusion, extrusion, or angulation. The variable depth technology wedge can be designed (alone or in concert with the Contour Attachment) such that the targeted tooth can make any one or more of the above-mentioned movements, concurrently. As used herein, “wedge” means “Variable Depth Technology Wedge.”

The variable depth technology wedge can be formed into virtually any shape. The surface of the variable depth technology wedge can be, but is not limited to being, substantially: rectangular, square, circular, triangular, polygonal or star shaped. The surface can also be curved. The surface of the variable depth technology wedge proximal to the large and substantially planar surface of the tooth (and/or proximal to the Contour Attachment) can outline a variety of shapes. The shapes include, but are not limited to, substantially: rectangular, square, triangular, trapezoidal, circular, or polygonal. Preferably, the surface of variable depth technology wedge outlines a substantially triangular or substantially trapezoidal shape.

The variable depth technology wedge can supply the force necessary to promote the desired movement of the targeted teeth. The variable depth technology wedge can be independently created and subsequently affixed to the aligner at the appropriate and/or desired position. Preferably, the variable depth technology wedge is an integral part of the aligner (i.e. the aligner and wedge are cast as a single object). In other words, the Variable Depth Technology Wedge and the aligner can be separate objects but are, preferably, cast as a single object. The wedge can comprise any of the materials or combination of materials as the aligner. The wedge and aligner need not comprise the same material. The wedge—particularly in the former case where the aligner and wedge are not cast as a single object—can comprise, for example, polymer, metal, wood, ceramic, or any other suitable material that is known to those of skill in the art.

In the latter case, where the Variable Depth Technology wedge and aligner are cast as a single object, the combined aligner with Variable Depth Technology Wedge can be cast from the three-dimensional model of the patient's teeth. The Variable Depth Technology Wedge and the aligner can be combined into a single unit using a variety of methods. Preferably, the model of the patient's teeth is altered prior to casting the Variable Depth Technology Wedge/aligner combination. Preferably, the model is altered by removing a portion of the targeted tooth in the model of the patient's teeth. Still more preferably, the portion removed from the targeted tooth corresponds to the desired dimensions and shape of the Variable Depth Technology Wedge.

Still more preferably, the dental health care professional selects the portion of the tooth in the model to carve away based on the desired tooth movement. Thereafter, when the wedge/aligner combination is cast from the altered model of the patient's teeth, the material used to make the aligner can fill the volume left behind by the removed or carved out portion of the tooth. Consequently, upon hardening, the material that hardened in conformity with the shape of the removed portion of the model can form the Variable Depth Technology Wedge portion of the aligner/Variable Depth Technology Wedge combination. Because the Variable Depth Technology wedge portion of the aligner occupies the volume carved away from the model of the patient's tooth, the Variable Depth Technology portion of the aligner will be in contact with the patient's actual tooth and exert pressure on the that tooth when the aligner is properly positioned in the patient's mouth.

The shape of the recess made in the model of the tooth can correspond somewhat to the shape of the supplemental blank occupying the desired final position of the tooth. Moreover, the recess can be deeper into the tooth at the region of the tooth that has to move the farthest, and can be shallower at the region of the tooth that has to move the least. Similarly, the depth and shape of the wedge can correlate with the shape of the supplemental blank occupying the desired final positioned of the tooth. The Variable Depth Technology Wedge can be thicker where it contacts the tooth at the region of the tooth that has to move the farthest, and can be thinner where it contacts the region of the tooth that has to move the least.

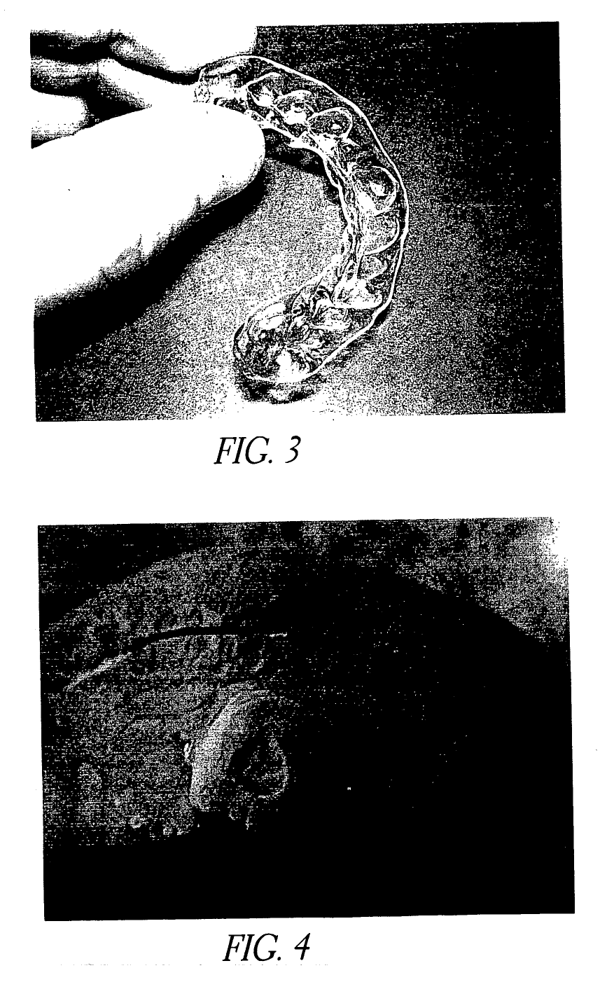

FIG. 4 shows an example of a recess carved or cut into a dental stone model of the patient's teeth. The recess has a substantially triangular perimeter, and it is not of uniform depth. The recess is not of uniform depth because the targeted motion of the tooth requires that the force exerted (by the resultant variable depth technology wedge) not be uniform across the face of the tooth. When the aligner is formed over this altered model, the built in variable depth technology wedge will have the dimensions of the recess. Consequently, the point on the patient's actual tooth in contact with thicker portion of the resultant Variable Depth Technology Wedge experiences a greater force than the point on the tooth in contact with the thinner portion of the wedge (or the points not in contact with the Variable Depth Technology Wedge at all)

If the appliance comprising the aligner and Variable Depth Technology Wedge combination is transparent or translucent, the dental health care professional can be able to visually confirm that the Variable Depth Technology Wedges are properly positioned. When the aligner with the built in wedge is inserted over the patient's teeth, the aligner will fog up except at the points where the wedge is in contact with the surface of the tooth. This enables the dental health care professional to visually confirm whether the Variable Depth Technology edge(s) is/are correctly positioned on the targeted teeth. Moreover, when the appliance containing one or more Variable Depth Technology wedges is inserted into the mouth, the patient can be able to feel the pressure points on the teeth caused by the wedges making contact with the surfaces of the teeth. The patient can be able to identify and describe what type of motion is being exerted on the individual teeth, based on the direction of the force they feel from the aligner and wedges. This can provide another opportunity for the dental health care professional to confirm that the aligner/Variable Depth Technology Wedge combination is properly designed and constructed.

The Contour Attachment

Another aspect of the present invention is the Contour Attachment. A Contour Attachment can be affixed to either the buccal or lingual surface (or both) of each tooth targeted for orthodontic or cosmetic adjustment. The Contour Attachment can comprise one or a plurality of ridges affixed to the surface of a tooth or it can comprise a dollop of material affixed to the surface of the tooth. When the Contour Attachment is affixed to an individual tooth it can work in concert with the variable depth technology wedge to enhance the magnitude and direction of the applied force and thereby permit finer control over the movement of the tooth. Also, the Contour attachment can work in concert with the Variable Depth Technology Wedge to prevent the appliance from moving when placed in the mouth.

Preferably, Contour Attachment material is durable enough to withstand the force on it when it is in communication with the aligner and/or Variable Depth Technology Wedge. Preferably, the Contour Attachment is constructed from material or materials impermanent enough to polish away from the surface of the patient's tooth when the desired tooth movement is achieved. Preferably, the material from which the Contour Attachment is made is substantially transparent.

The Contour Attachment can promote second-degree movement of the teeth, which includes but is not limited to, movement such as rotation. If the patient does not require second degree movement of a tooth, then the patient can not require the Contour Attachment to be placed on the tooth.

While not limited to the following, the Contour Attachments can comprise, for example, a bondable composite, epoxy, or bondable polymer. Preferably, the Contour Attachment comprises of a light cured, flowable composite.

Preferably, the Contour Attachment comprises one or a plurality of ridges on the buccal or lingual surface of the targeted teeth. Even more preferably the Contour Attachment comprises a single, continuous ridge on the surface of the targeted tooth. More preferably, the Contour Attachment is in a substantially polygonal shape. Still more preferably the Contour Attachment is substantially circular in shape on the surface of the targeted tooth. More preferably, the Contour Attachment is ramp shaped. Even more preferably, the Contour Attachment forms an approximately circular concave surface on the tooth. More preferably, the Contour Attachment is bowl-shaped on the surface of the tooth. More preferably, the Contour attachment is bagel or donut shaped on the surface of the tooth.

The Contour Attachments can work in concert with the aligner and/or the variable depth technology wedge. Preferably, the variable depth technology wedge, regardless of its shape, sits entirely within the Contour Attachment when the appliance is positioned in the mouth. If the variable depth technology wedge fits within the boundaries of the Contour Attachment, it is preferable that the wedge contacts the Contour Attachment at one or more points. Contact between the variable depth technology wedge and the Contour Attachment enables precise and measured force to be applied to the tooth in order to cause the desired tooth movement. More preferably, the variable depth technology wedge and the Contour Attachment engage a manner that is similar to post-style snap. Preferably the variable technology wedge and the Contour Attachment overlap for at least a portion of their areas. Preferably, the variable depth technology wedge has a post-like formation extending to, or slightly above, its surface, the post being in communication with the surface of the tooth to be moved or in communication with the hollow of the Contour Attachment. More preferably this post is of the appropriate dimensions to be inserted into a concave hollow defined by the substantially bagel shaped Contour Attachment on the surface of the targeted tooth. The extrusion on the wedge can work in concert with the Contour Attachment to apply measured, three-dimensional force to the surface of the tooth targeted for movement.

The Contour Attachment can increase the net force on the targeted tooth. The Contour Attachment can be added to the patient's tooth after the aligner or aligner/wedge combination has been cast from the altered or unaltered model. If it is added after the appliance has been cast, then the aligner and/or wedge can be in contact with the Contour Attachment when the appliance is inserted, and the tooth with the Contour Attachment can experience greater force. The increased force will promote the targeted tooth's movement into the movement volume created by the supplemental blank. Thus, one aspect of the Contour Attachments is that they perform the function of simply increasing the force on the tooth to move it into its desired position resulting from an effective reduction in the distance (or effective increase in the pressure) between the appliance and the tooth, with the attachment.

The Contour Attachment promotes second degree tooth movement. As discussed above, simple Contour Attachments on the teeth increase the force and promote accelerated movement of the tooth into its targeted position. To promote second degree movement like rotation, angulation, intrusion or extrusion, more sophisticated designs of the Contour Attachment are preferable. The preferred designs of the Contour Attachment include, but are not limited to, substantially the shape of a: berm, ramp, saucer, bagel, wedge, triangular pyramid, square pyramid, cone, frusto pyramid, frusto cone, trapezoidal pyramid.

The Contour Attachment, whatever its shape, can be completely shelled out or hollowed out such that the Contour Attachment forms the perimeter of a substantially polygonal shape or forms the perimeter of a closed or substantially closed shape. More preferably, the Contour Attachment, whatever its shape, is not completely shelled out or hollowed out such that the Contour Attachment merely forms the perimeter of a substantially polygonal shape or forms the perimeter of a closed or substantially closed shape. The Contour Attachment can be hollowed such that it forms the perimeter of a closed shape, substantially closed shape, substantially polygonal shape, single substantially linear ridge, multiple substantially linear ridges, single substantially nonlinear ridge, or multiple substantially nonlinear ridges on the surface of the tooth.

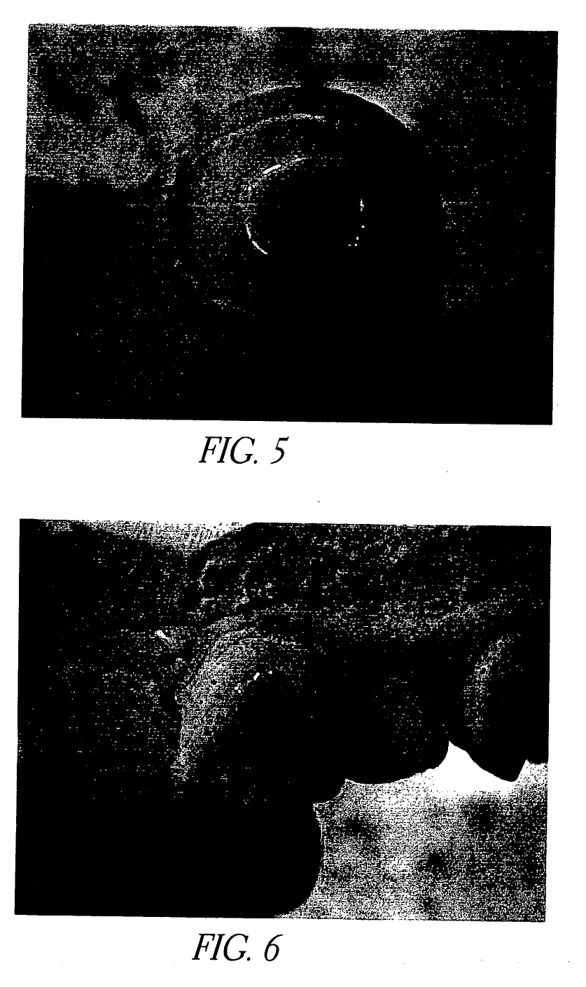

FIG. 5 shows one of the preferred shapes of a Contour Attachment (applied to a fingernail for clarity). In this depiction, the Contour Attachment's shape can be described as substantially circular, or perhaps that of a bagel or donut. In this depiction, the interior region of the contour attachment is hollowed out such that the middle area is substantially free of the composition.

The Contour Attachment, however, can also have a saucer-like design. In such a design, the material at the perimeter of the Contour Attachment is thicker than the material in the region within the perimeter. That hollow or concave central portion of a saucer-shaped Contour Attachment can be made of the same material as the perimeter of the Contour Attachment. The Contour Attachment could be hollowed out and used simply as a guide for second degree motion such as intrusion or extrusion. However, it can also have a thickness over its entire surface area such that it aids in the pushing of the tooth into its targeted position.

Preferably, the dental healthcare professional simply adds a ridge of Contour Attachment material to the tooth of the proper shape and with the thicknesses necessary to move the tooth to its desired final position. Preferably, the material used to make the Contour Attachment is applied, for example, as a lump, dollop, drop, ridge or berm-like formation of material on the surface of the tooth. Preferably the Contour Attachment material is in liquid or semi-solid form upon application. More preferably, the material hardens. Preferably, the material of the Contour Attachment is easily polished off using conventional means when the desired tooth movement is achieved.

Preferably, the Contour Attachment is shaped using a dental instrument, such as a dental pick, spatula, hook, carver, scraper, polisher, or any other suitable tool that is known to one of ordinary skill in the art. Preferably, the final shape of the Contour Attachment is substantially circular or substantially elliptical. Preferably, the result of using the tool is that the center area of the Contour Attachment is made substantially free of material such that there is little or no Contour Attachment matter between that central portion of the surface of the tooth and the plastic aligner (other than the outlining ridge of the Contour Attachment). One of ordinary skill in the art, however, will understand that the hollow portion of the Contour Attachment need not be substantially free of material.

FIG. 6 depicts a Contour Attachment made by applying a dollop of material and distributing the material over a substantially triangular area by hand such that the attachment has varying thickness. While it can not be readily apparent from the figure, the perimeter of the contour attachment is thicker than the central portion. For illustrative purposes, the Contour Attachment shown here is applied to the surface of a model of a patient's teeth rather than the actual teeth of a patient.

Another advantage of adding a hardening material to form the Contour Attachment is that it will typically be a more coarse material than the tooth. Because it is a coarse material, there is friction between it and the aligner and/or Variable Depth Technology Wedge. When the Variable Depth Technology Wedge and the Contour Attachment are in contact, the Variable Depth Technology Wedge is held more firmly in place and is less likely to slide around against the smooth, slippery surface of the tooth. The increased friction increases the amount of force that can be applied to the targeted tooth to move it into its correct position. It can also be desirable to roughen up the surface of the tooth to increase the friction between the aligner and/or Variable Depth Technology Wedge and the surface of the tooth in order to promote the movement of the tooth into its correct position more quickly. The advantage of the ability to increase the force on the tooth is that the treatment period can be decreased and patient compliance can be increased.

The desired shape and thickness of the Contour Attachment can depend on the movement desired for the targeted tooth. By making the Contour Attachment thicker at places, the direction of the force on the tooth can be tuned. Moreover, the Variable Depth Technology Wedge and the Contour Attachment work in concert to promote second degree movement. By providing additional surfaces against which the aligner and the Variable Depth Technology Wedge can push (that is, in addition to the surface of the tooth alone) the fulcrum of the tooth's movement can be substantially changed. When the Contour Attachment and the Variable Depth Technology Wedge are appropriately designed and in communication, the fulcrum of movement will be shifted from the root of the tooth (as in first degree movement). If the fulcrum of motion is somewhere other than at the root, the root itself can be moved, and second degree motion of the tooth can be promoted.

One of ordinary skill in the art will recognize that, while some of the embodiments described herein have the Variable Depth Technology Wedge, or a portion thereof, fit within the perimeter of the Contour Attachment, the apparatus can be designed such that the Wedge is, for example, bagel shaped and the Contour Attachment is shaped such that it partially or wholly fits within the perimeter of the Wedge to promote the desired movement.

The Variable Depth Technology Wedge and Contour Attachment can operate in concert to promote second degree movement. It is therefore desirable to establish their relative positions as well as possible. One method to determine whether the Contour Attachment is properly positioned relative to the Variable Depth Technology wedge of the aligner is by putting the aligner/Variable Depth Technology Wedge combination into position over the patient's teeth. Because the Contour Attachment is preferably added to the surface of the tooth after the appliance is cast, the Contour Attachment will be in contact with the appliance. As such, the dental healthcare professional is able to see the impression of the aligner against the plastic of the aligner/wedge combination and thereby determine if the Variable Depth Technology wedge and Contour Attachment are in appropriate communication. Preferably, this determination is done under magnification so that the dental healthcare professional can properly position the aligner with the variable depth technology wedge.

If the Contour Attachment and the variable depth technology wedge are not in proper communication when the Contour Attachment is initially placed on the tooth, the dental healthcare professional can adjust the position and depth of the wedge itself by using the heated pliers discussed below, or the Contour Attachment can be polished away, altered, built up or decreased as necessary in order to achieve the interaction that the dental healthcare professional desires. In order to improve test the relative positioning of the Variable Depth Technology wedge with the Contour Attachment, the Contour Attachment material should be hardened before the aligner with the Variable Depth Technology Wedge is placed over the teeth. The material, being flowable, cannot make a good fit with the aligner prior to being completely hardened. Fine adjustments to the shape, depth and surface of the Contour Attachment are preferably done with a polisher.

Other methods by which the dental health care professional can assess the communication between the Contour Attachment and the Variable Depth Technology Wedge and/or aligner is to use colored water. If the appliance is clear plastic then the colored water will indicate the position on the aligner where there is contact with the Contour Attachment. If the appliance is opaque, one method by which the dental health care professional can assess the communication between the Contour Attachment and the Variable Depth Technology Wedge and/or aligner is to use colored talcum powder. Wherever the Contour Attachment and the aligner/wedge bind, there will be a colored mark from the talcum powder. In reality, dental health care professionals will not find it difficult to simply visually estimate the correct position of the Contour Attachment and apply it to the patient's tooth.

Preferably, the sequence followed by the dental health care professional to create the Contour Attachment and check its alignment with the Variable Depth Technology Wedge is as follows: first, apply a dollop or ring of the hardening material on the surface of the patient's tooth. Second, harden the Contour Attachment material onto the surface of the tooth. Third, put the aligner and Variable Depth Technology Wedge combination over the patient's teeth with the Contour Attachment in place. Fourth, determine whether the Contour Attachment and the wedge are in proper alignment, preferably by any of the methods described above. Fifth, if applicable, use a polisher to hollow out or create a recess in the dollop of the material that forms the Contour Attachment. Sixth sculpt the surface of the Contour Attachment, if necessary, to work in concert with the variable depth technology wedge to promote the desired movement of the patient's tooth. Seventh, when the patient's teeth are in their desired positions, polish off the Contour Attachments.

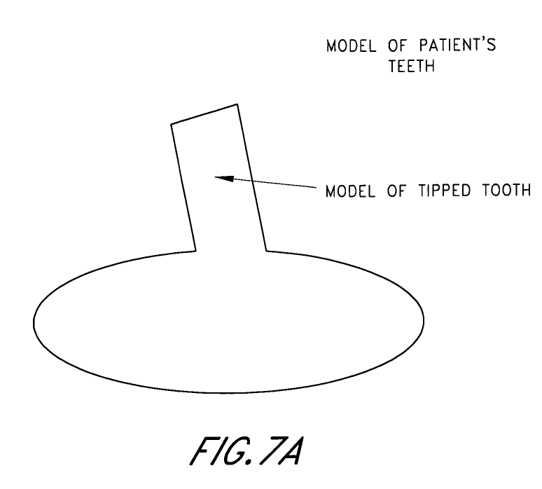

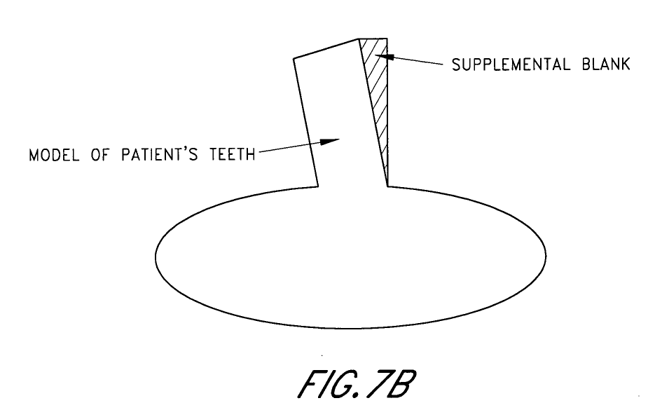

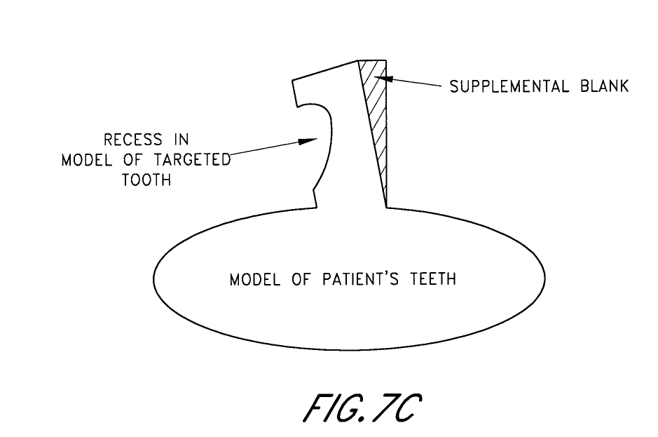

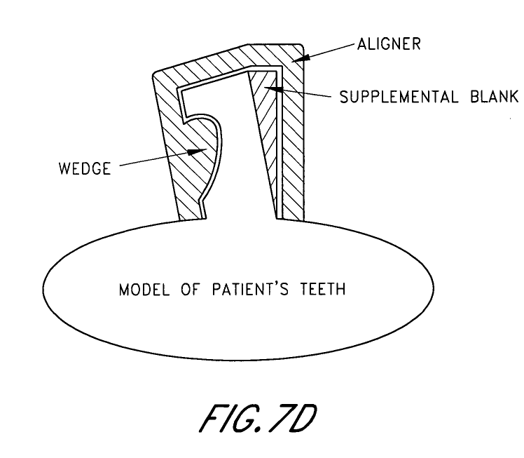

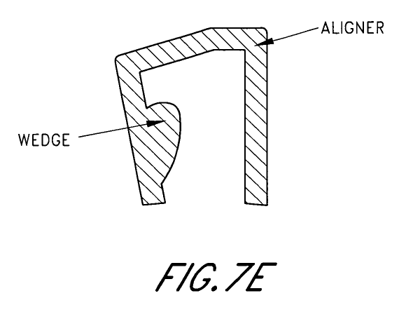

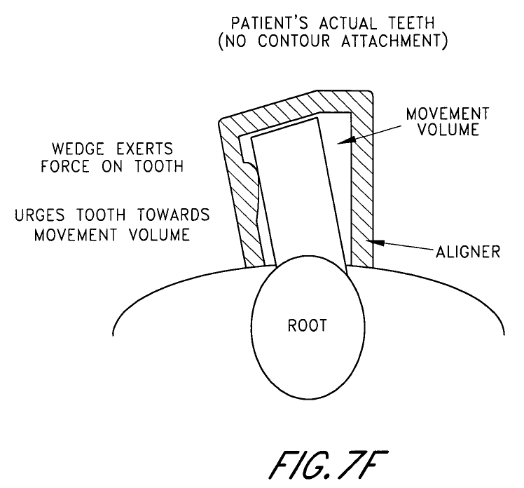

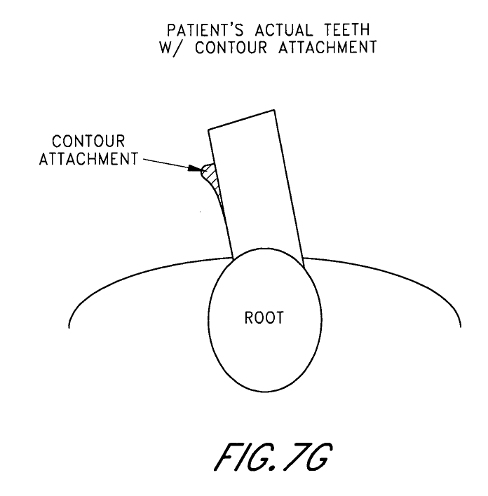

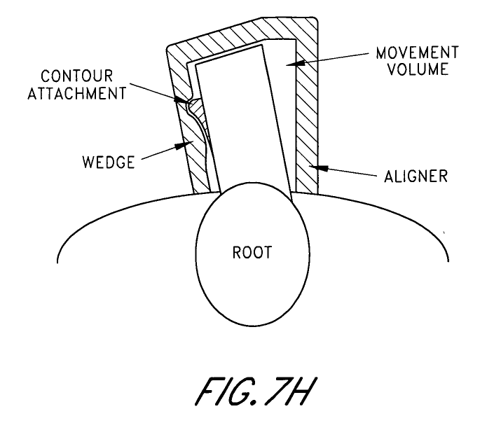

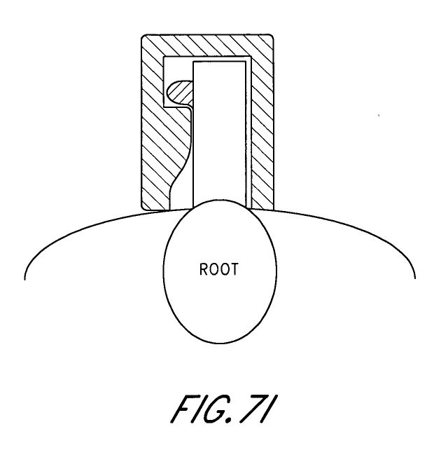

FIG. 7 is a schematic diagram showing some of the aspects of the present invention disclosed herein. FIG. 7a represents a cross-sectional view of a model of a tooth. The tooth, in this representation, is tipped out of its correct (vertical) position. FIG. 7b shows the same model but with the addition of a supplemental blank. The supplemental blank occupies at least a portion of the space in the model where the tooth should be. FIG. 7c shows the same model with both the supplemental blank, and a recess carved into the model of the tooth. The recess is not of uniform depth in this example. The recess is cut deeper into the model of the tooth near the top. This is because the top of the tooth must move farther than the bottom of the tooth to achieve the desired result. FIG. 7d shows an aligner being molded over the altered model of the teeth. The aligner does not displace the supplemental blank. Moreover, the aligner material fills in the recess to form a Variable Depth Technology Wedge that conforms to the shape of the recess. In this example, the aligner and Wedge are of unit construction.

FIG. 7e shows the shape of the completed aligner when it is removed from the model of the patient's teeth. The bulge on the interior of the left side of the aligner is a Variable Depth Technology wedge. It will exert force on the patient's tooth, either alone or in concert with a Contour Attachment, when the aligner is inserted into the patient's mouth. FIG. 7f shows a case where the aligner/wedge combination is used without a Contour Attachment. The pressure on the tooth caused by the presence of the Variable Depth Technology wedge urges the tooth toward its targeted position. The movement is aided by the fact that there is a movement volume available to the tooth such that the tooth is not substantially impeded by the opposite side of the aligner.

FIG. 7g is an example of a patient's tooth having a Contour Attachment on one of its surfaces. In this case, the Contour Attachment is substantially ramp shaped with the thicker portion of the ramp closer to the tip of the tooth. FIG. 7h shows the aligner with the Variable Depth Technology wedge positioned over the patient's tooth with Contour Attachment. The wedge and the contour attachment work in concert to apply force to the patient's tooth to move it into its targeted position. The Contour Attachment's engagement of the wedge also prevents the aligner from slipping off the patient's teeth. Finally, FIG. 7i shows the tooth in its targeted position.

Tuning the Treatment

Moving a patient's teeth is a dynamic process. It can be that after some period of time using the aligner, the patient can stop feeling the pressure from the Variable Depth Technology Wedges against the teeth. If the patient no longer feels the force on the teeth, then the dental health care professional can want to increase the force of the wedges on the teeth, particularly if the teeth are not yet in their targeted position. There are two preferred ways to increase the force on the teeth: first, the dental health care professional can increase the depth of any selected Variable Depth Technology Wedge; and second, the dental health care professional can add bonding material to the surface of the patient's tooth.

In the former, if the Variable Depth Technology Wedge and Aligner are separate objects, then the dental health care professional could remove the used wedge and affix a second, thicker and/or differently shaped Variable Depth Technology Wedge to the aligner. By so doing, there can be a change in the contact surfaces with the teeth, the applied force to the targeted teeth can increase, and the desired movement can be completed. Similarly, if the Variable Depth Technology Wedge and Aligner is an integrated unit made of thermoplastic, the dimensions of the existing Variable Depth Technology Wedge component can be changed. This can be accomplished using a tool such as pliers, a crimping tool, or any other suitable tool that can be known to those of skill in the art. Preferably, the tool, pliers or crimping tool has a head with approximately the same shape as the face of the Variable Depth Technology Wedge in the aligner. Preferably the tool is heated to approximately 140 degrees and the thermoplastic aligner is immersed in warm water. When the thermoplastic has softened in the water, the tool is inserted into the appliance at the Variable Depth Technology Wedge position, and the depth of the wedge in the thermoplastic is increased to whatever depth is desired using the heated tool. That is, when the tool is applied to the Variable Depth Technology Wedge/aligner, there is a corresponding increase the depth of the wedge.

Using either of these methods, the dental health care professional is able to adjust the depth of the Variable Depth Technology Wedges on a single aligner appliance rather than using a series of appliances. Consequently, costs to the patient are reduced for the orthodontic and/or cosmetic treatment.

Single Aligner

One aspect of the apparatus and methods disclosed herein is that they typically only require the use of a single aligner to achieve the desired movement of the targeted teeth. Preferably, the aligner and Variable Depth Technology Wedge combination is constructed from 0.040 medical grade thermoplastic. This corresponds to a plastic wall thickness of one-half inch. One advantage of the thick thermoplastic utilized herein is that the appliance is more durable. For example, the 0.020 thermoplastic appliances typically wear out in two-to-three weeks. The 0.040 thermoplastic (1 mm thick) endures for three months or more. Consequently, the aligner of the present invention can last for the entire period of treatment. As such, the patient requires only one appliance and the patient's costs for the treatment are reduced.

Another advantage of using the thicker plastic is that the dental health care professional can target adjacent teeth for concurrent movement. If thin plastic is used, then teeth adjacent to a targeted tooth must act as anchors for that tooth. Therefore, a series of alternating appliances must be used to move the adjacent targeted teeth. If the dental health care professional attempted to move adjacent teeth simultaneously with a thinner plastic appliance, none of the teeth would move because the plastic would essentially give way. The ability of the thick walled aligner of the present invention to move adjacent teeth concurrently is advantageous because it reduces the treatment duration (which increases patient compliance), and can obviate the need for multiple appliances.

A related advantage of utilizing thick thermoplastic material for the aligner and wedge pair is that it can be possible to apply greater force to the targeted tooth. The thick plastic not only provides for better anchoring against the tooth, but the increased rigidity of the thick plastic increases the force of the Variable Depth Technology Wedges against the teeth.

Each component of the aligner, Variable Depth Technology Wedge and Contour Attachment system of the apparatus disclosed herein, is preferably handcrafted. By handcrafting the aligner, Variable Depth Technology Wedge and Contour Attachment, the dental health care professional can finely tune the force applied to the targeted teeth.

Moreover, the process of moving teeth is dynamic. The material used to make the aligner and Variable Depth Technology Wedge is of a type that can be molded by the health care professional over the course of the treatment. By using a heating tool, for example, the dental health care professional can make adjustments to the Variable Depth Technology Wedge during an appointment with the patient. Similarly, the preferred construction of the Contour Attachment is such that it can be altered, removed and/or redesigned with relative ease. Therefore, the handcrafted components disclosed herein, which are independently adjustable by the dental health care professional as conditions change, can improve efficacy, efficiency and can reduce the cost of the desired treatment. This, too, reduces the costs of the orthodontic or cosmetic adjustment of teeth because the same appliance can be used for the entire duration of the treatment.

Safety and Efficacy

Another aspect of the method and apparatus disclosed herein is that second degree movement of teeth can be induced without causing root resorption or the death of the tooth's nerve. The preferred thermoplastic thickness and/or preferred Contour Attachment designs substantially reduce the possibility of root or nerve damage. If there is too much force placed on a tooth (through the Variable Depth Technology Wedge and/or Contour Attachment), the Variable Depth Technology Wedge will slip harmlessly out of the Contour Attachment, and the force against the root will be mitigated. If there is too much force on the tooth, the wedge itself deform, again mitigating the force acting on the root of the tooth. Consequently, the likelihood of root resorption, and thus damage to the nerve, is substantially reduced. Various preferred embodiments contain this inherent protection against nerve damage/root resorption. The preferred thermoplastic to use for the aligner and Variable Depth Technology Wedge in order to maintain the balance between the force necessary to move the targeted teeth, and avoiding the excessive force that can cause root resorption, is 0.040 (1 mm thick) thermoplastic.

Another advantage of the apparatus, technique and method disclosed herein is that it is more comfortable than the traditional bracket and band apparatus and method of orthodontics and cosmetic dentistry. Conventional methods of orthodontics and cosmetic dentistry use braces that are constructed of metallic and ceramic brackets and wires. The metallic and ceramic brackets and wires irritate cheek tissue, lips and the tongue. The method and apparatus of the current invention is nonmetallic and therefore causes less irritation to the mouth over the course of the treatment period.

Moreover, when adjustments need to be made to the apparatus of the current invention, there is less discomfort as compared to the bracket and band method of orthodontics. In the traditional method of orthodontics, adjusting the force on the teeth is accomplished by tightening the wire in contact with the teeth. When this is done, there tends to be considerable discomfort to the patient over the short term. The fear of discomfort associated with tightening the bracket and band braces can discourage the patient from complying with the appointment schedule and thereby jeopardize the desired result. The method and apparatus disclosed herein do not require adjustments of the kind that have been used traditionally in orthodontics. If changes to the apparatus need to be made over the course of the treatment, the alterations made to the Aligner, Variable Depth Technology Wedge and/or Contour Attachment are substantially painless. This is a significant and desirable improvement. Moreover, the present invention involves greater flexibility than traditional orthodontics in making adjustment to the amount of force, as well as the direction of force on individual teeth. This is done quickly chair-side, as opposed to difficult and time consuming adjustments to conventional fixed braces and/or other aligner systems.

The removable nature of the apparatus disclosed in the present invention is an advantage over traditional braces constructed of metallic and ceramic brackets and wires. Because the appliance of the present invention is removable, it is more convenient for the patient to clean and maintain. Proper cleaning and maintenance of the apparatus leads to better dental health because the teeth and gums are exposed to less matter that can cause tooth decay or gum disease.

The method and apparatus of the present invention can also improve the efficacy of orthodontic and cosmetic treatment. Some embodiments and methods promote the concurrent movement of all targeted teeth by applying precise, controlled force at specific points. Compared to the coarse, broad force of the bracket and band method, and the alternating, intermittent treatment of other aligner systems, the methods and apparatus of the present invention reduces the possibility of improperly moving teeth, and increases the likelihood of precise and concerted orthodontic and cosmetic adjustments, as well as the ability to change tooth positions, mid-treatment, as the need or desire arises, based on a change in the patient or health care professional's expectations or desired end result.

The methods and apparatus disclosed herein are also capable of working in concert with the traditional bracket and band method. In some embodiments of the present method, the upper teeth move more quickly than the lower teeth. The reason that the upper teeth can move more quickly is that the upper teeth have a greater facial surface area. This allows for more flexibility in designing the Variable Depth Technology Wedges and the Contour Attachments.

In some embodiments, it can occasionally be worthwhile to use bracket and band braces on the lower teeth, and the methods and apparatus disclosed herein on the top teeth. This encourages all the teeth complete their movement at the same time. It can be less objectionable to patients than using bracket and band braces alone because patients recognize that brackets on the lower teeth are less visible than on the top teeth. Even if the bracket and band braces are used on the lower teeth, however, it can be desirable to use an aligner of the present invention when the bracket and band braces are removed. After the bracket and band braces are removed, the teeth are very mobile in the bone. Preferably, an aligner is used to make minor or final corrections to the placement of the teeth and to maintain the teeth in their correct positions.

Another aspect of the apparatus and methods disclosed herein is that a General Practitioner can be able to practice and use them. Therefore, the kinds of cosmetic tooth movement ordinarily associated with bracket and band braces that can now be done by general practitioners rather than specialized orthodontists. These techniques can be combined with other forms of general dentistry such as minor tooth repair, bonding, cleaning and whitening and gum care. This is an advantage because the patient can have the targeted teeth moved into the correct position, have minor tooth repair completed, and have their cleaning done at the same office and by the same general practitioner.

Another aspect of the method and apparatus is that specific teeth can be targeted for movement without changing the position of all the patient's teeth. Most adults are primarily concerned with the front four to eight teeth on the top and front four to eight teeth on the bottom. Typically, a patient will request that one or two teeth be repositioned for appearance or health reasons, without moving any adjacent teeth. The present invention is capable of fulfilling such requests easily and in a short period of time. Generally speaking, by the time one is an adult, they are comfortable with their bite (which involves the molars), and they have no inclination to try to change their bite. Therefore, the method and apparatus of the present invention enables those patients seeking purely cosmetic changes to correct their smile in as little as 30 days.

One aspect of the present invention is an aligner. In some embodiments, the aligner comprises plastic. In some embodiments the plastic is thermoplastic. In some embodiments the thermoplastic is medical grade thermoplastic. In some embodiments, the plastic is between about one-eighth mm and about one mm thick. In other embodiments, the plastic is between about one-quarter mm and about three-quarter mm thick. In still other embodiments, the plastic is between about three-eighths mm and about five-eighths mm thick. In still other embodiments, the plastic is between about 0.4 mm and about 0.6 mm thick. In other embodiments, the plastic is between about 0.45 mm and about 0.55 mm thick. In other embodiments, the plastic is about 0.5 mm thick. In other embodiments, the plastic is about 0.50 mm thick.

In some embodiments, the aligner is substantially transparent. In other embodiments, the aligner is substantially translucent. In other embodiments, the aligner is substantially opaque. In other embodiments, the aligner is partially substantially transparent. In other embodiments the aligner is partially substantially translucent. In other embodiments, the aligner is partially substantially opaque. In other embodiments, the aligner is partially substantially transparent and partially substantially translucent. In other embodiments, the aligner is partially substantially transparent and partially substantially opaque. In other embodiments, the aligner is partially substantially translucent and partially substantially opaque. In other embodiments, the aligner is partially substantially transparent, partially substantially translucent and partially substantially opaque.

In some embodiments, the aligner comprises a Variable Depth Technology Wedge. In some embodiments, the Variable Depth Technology wedge is affixed to the aligner. In other embodiments the aligner and Variable Depth Technology Wedge is of unit construction. In some embodiments, the Variable Depth Technology Wedge is cast as part of the aligner. In still other embodiments the Variable Depth Technology Wedge is formed into a pre-formed aligner. In some embodiments, the Variable Depth Technology Wedge is formed into a pre-formed aligner using a crimping tool. In other embodiments the Variable Depth Technology Wedge is formed into the aligner using a drill.

In some embodiments, the approximate shape defined by the perimeter of the face of the Variable Depth Technology Wedge proximal to the patient's teeth is substantially triangular. In some embodiments, the face of the Variable Depth Technology Wedge proximal to the patient's teeth is substantially trapezoidal. In some embodiments, the face of the Variable Depth Technology Wedge proximal to the patient's teeth is substantially circular. In some embodiments, the face of the Variable Depth Technology Wedge proximal to the patient's teeth is substantially elliptical. In some embodiments, the face of the Variable Depth Technology Wedge proximal to the patient's teeth is substantially star shaped. In some embodiments, the face of the Variable Depth Technology Wedge proximal to the patient's teeth is substantially oval. In some embodiments, the face of the Variable Depth Technology Wedge proximal to the patient's teeth is substantially square. In some embodiments, the face of the Variable Depth Technology Wedge proximal to the patient's teeth is substantially rectangular. In some embodiments, the face of the Variable Depth Technology Wedge proximal to the patient's teeth is substantially polygonal. In some embodiments, the face of the Variable Depth Technology Wedge proximal to the patient's teeth is substantially rhombus-shaped. In some embodiments, the face of the Variable Depth Technology Wedge proximal to the patient's teeth is substantially crescent-shaped. In some embodiments, the face of the Variable Depth Technology Wedge proximal to the patient's teeth is substantially frusto crescent shaped. In some embodiments, the face of the Variable Depth Technology Wedge proximal to the patient's teeth is substantially in the shape of a letter of the alphabet. In some embodiments, the face of the Variable Depth Technology Wedge proximal to the patient's teeth is substantially “s” shaped. In some embodiments, the face of the Variable Depth Technology Wedge proximal to the patient's teeth is substantially “T” shaped. In some embodiments, the face of the Variable Depth Technology Wedge proximal to the patient's teeth is substantially “O” shaped. In some embodiments, the face of the Variable Depth Technology Wedge proximal to the patient's teeth is substantially “X” shaped. In some embodiments, the face of the Variable Depth Technology Wedge proximal to the patient's teeth is substantially “U” shaped. In some embodiments, the face of the Variable Depth Technology Wedge proximal to the patient's teeth is substantially “D” shaped.

In some embodiments, the approximate shape of the Variable Depth Technology Wedge is substantially conical. In some embodiments, the approximate shape of the Variable Depth Technology Wedge is substantially frusto conical. In some embodiments, the approximate shape of the Variable Depth Technology Wedge is substantially pyramidal. In some embodiments, the approximate shape of the Variable Depth Technology Wedge is substantially frusto pyramidal. In some embodiments, the approximate shape of the Variable Depth Technology Wedge is substantially square pyramidal. In some embodiments, the approximate shape of the Variable Depth Technology Wedge is substantially frusto square pyramidal. In some embodiments, the approximate shape of the Variable Depth Technology Wedge is substantially triangular pyramidal. In some embodiments, the approximate shape of the Variable Depth Technology Wedge is substantially frusto triangular pyramidal. In some embodiments, the approximate shape of the Variable Depth Technology Wedge is substantially square cubic. In some embodiments, the approximate shape of the Variable Depth Technology Wedge is substantially rectangular cubic. In some embodiments, the approximate shape of the Variable Depth Technology Wedge is substantially spherical. In some embodiments, the approximate shape of the Variable Depth Technology Wedge is substantially semi spherical. In some embodiments, the approximate shape of the Variable Depth Technology Wedge is substantially hemispherical. In some embodiments, the approximate shape of the Variable Depth Technology Wedge is substantially cylindrical. In some embodiments, the approximate shape of the Variable Depth Technology Wedge is substantially frusto cylindrical. In some embodiments, the approximate shape of the Variable Depth Technology Wedge is substantially semi cylindrical. In some embodiments, the approximate shape of the Variable Depth Technology Wedge is substantially hemi cylindrical. In some embodiments, the approximate shape of the Variable Depth Technology Wedge is substantially ellipsoidal. In some embodiments, the approximate shape of the Variable Depth Technology Wedge is substantially semi ellipsoidal. In some embodiments, the approximate shape of the Variable Depth Technology Wedge is substantially paraboloidal. In some embodiments, the approximate shape of the Variable Depth Technology Wedge is substantially semi parabaloidal. In some embodiments, the approximate shape of the Variable Depth Technology Wedge is substantially parabolic hyperboloidal. In some embodiments, the approximate shape of the Variable Depth Technology Wedge is substantially semi parabolic hyperboloidal. In some embodiments, the approximate shape of the Variable Depth Technology Wedge is substantially hemi parabolic hyperboloidal.

Another aspect of the present invention is the model of the patient's teeth. In some embodiments, the model is a three-dimensional model. In some embodiments the model comprises a rigid material. In some embodiments, the model comprises a malleable material. In some embodiments, the model comprises a brittle material. In some embodiments, the model comprises a carvable material. In some embodiments, the model comprises a drillable material. In some embodiments, the model comprises a metal. In some embodiments, the model comprises a pliable material. In some embodiments, the model comprises a ductile material. In some embodiments, the model comprises plastic. In other embodiments, the model comprises porcelain. In other embodiments the model comprises glass. In other embodiments, the model comprises silicone. In still other embodiments, the model comprises dental stone.

In some embodiments, the model of the patient's teeth is altered. In some embodiments, the model is altered by hand. In other embodiments, the model is altered by machine. In other embodiments, the model is altered by hand and by machine. In other embodiments, the model is altered with the aid of a computer.

In some embodiments, the altered model comprises a supplemental blank. In some embodiments, the supplemental blank comprises a pliable material. In some embodiments, the supplemental blank comprises a workable material. In some embodiments, the supplemental blank comprises a malleable material. In some embodiments, the supplemental blank comprises a moldable material. In some embodiments, the supplemental blank comprises a pliant material. In some embodiments, the supplemental blank comprises a flexile material. In some embodiments, the supplemental blank comprises a rigid material. In some embodiments, the supplemental blank comprises a semi-rigid material. In some embodiments, the supplemental blank comprises a hardening material. In some embodiments, the supplemental blank comprises a hardened material. In some embodiments, the supplemental blank comprises a hardenable material. In some embodiments, the supplemental blank comprises a formable material. In some embodiments, the supplemental blank comprises a supple material. In some embodiments, the supplemental blank comprises a wax. In some embodiments, the supplemental blank comprises a rubber. In some embodiments, the supplemental blank comprises a plastic. In some embodiments, the supplemental blank comprises metal. In some embodiments, the supplemental blank comprises clay. In some embodiments, the supplemental blank comprises a mineral. In some embodiments, the supplemental blank comprises putty. In some embodiments, the supplemental blank comprises resin. In some embodiments, the supplemental blank comprises glass. In some embodiments, the supplemental blank comprises silicate. In some embodiments, the supplemental blank comprises block-out resin.

In some embodiments, the supplemental blank is hardenable. In some embodiments, the supplemental blank hardens over time. In some embodiments, the supplemental blank hardens with light. In some embodiments, the supplemental blank hardens with heat. In some embodiments, the supplemental blank hardens with radiation.

In some embodiments of an altered model, a supplemental blank substantially occupies the approximately correct position of a misaligned tooth. In some embodiments of an altered model, a supplemental blank partially occupies the approximately correct position of a misaligned tooth. In some embodiments of an altered model, a supplemental blank substantially occupies the volume between the targeted tooth and the approximately correct position of a misaligned tooth. In some embodiments of an altered model, a supplemental blank substantially occupies both the volume between the targeted tooth and the approximately correct position of a misaligned tooth, and the approximately correct position of a misaligned tooth. In some embodiments of an altered model, a supplemental blank partially occupies the volume between the targeted tooth and the approximately correct position of a misaligned tooth. In some embodiments of an altered model, a supplemental blank partially occupies both the volume between the targeted tooth and the approximately correct position of a misaligned tooth, and the approximately correct position of a misaligned tooth. Some embodiments of the altered model comprise a single supplemental blank. Other embodiments of the altered model comprise a plurality of supplemental blanks.

In some embodiments, the altered model comprises a recess. In other embodiments, the altered model comprises a plurality of recesses. In some embodiments, a tooth in the model comprises a recess. In some embodiments a tooth in the model comprises a plurality of recesses. In other embodiments, a plurality of teeth in the model comprises a plurality of recesses. In some embodiments, the recess is carved into the model. In some embodiments, the recess is drilled into the model. In some embodiments, the recess is bored into the model. In some embodiments, the recess is chipped into the model. In some embodiments, the recess is scooped out of the model. In some embodiments, the recess is ground out of the model. In some embodiments the recess has a maximum depth. In some embodiments, the recess has a maximum depth greater than one-half of the thickness of the tooth. In some embodiments the recess has an average depth. In some embodiments, the recess has an average depth greater than about one-half of the thickness of a tooth. In some embodiments the recess has a minimum depth. In some embodiments, the recess has a minimum depth greater than about one-half of the thickness of a tooth. In some embodiments, the recess has a maximum depth less than about one-half of the thickness of a tooth. In some embodiments, the recess has a minimum depth less than about one-half of the thickness of a tooth. In some embodiments, the recess has an average depth less than about one-half of the thickness of a tooth.

In some embodiments, the recess in the model has a shape. In some embodiments, the approximate shape defined by the perimeter of the face of the Recess proximal to the surface of the patient's teeth is substantially triangular. In some embodiments, the face of the Recess proximal to the surface of the patient's teeth is substantially trapezoidal. In some embodiments, the face of the Recess proximal to the surface of the patient's teeth is substantially circular. In some embodiments, the face of the Recess proximal to the surface of the patient's teeth is substantially elliptical. In some embodiments, the face of the Recess proximal to the surface of the patient's teeth is substantially star shaped. In some embodiments, the face of the Recess proximal to the surface of the patient's teeth is substantially oval. In some embodiments, the face of the Recess proximal to the surface of the patient's teeth is substantially square. In some embodiments, the face of the Recess proximal to the surface of the patient's teeth is substantially rectangular. In some embodiments, the face of the Recess proximal to the surface of the patient's teeth is substantially polygonal. In some embodiments, the face of the Recess proximal to the surface of the patient's teeth is substantially rhombus-shaped. In some embodiments, the face of the Recess proximal to the surface of the patient's teeth is substantially crescent shaped. In some embodiments, the face of the Recess proximal to the surface of the patient's teeth is substantially frusto crescent shaped. In some embodiments, the face of the Recess proximal to the surface of the patient's teeth is substantially “s” shaped. In some embodiments, the face of the Recess proximal to the surface of the patient's teeth is substantially “T” shaped. In some embodiments, the face of the Recess proximal to the surface of the patient's teeth is substantially “O” shaped. In some embodiments, the face of the Recess proximal to the surface of the patient's teeth is substantially “X” shaped. In some embodiments, the face of the Recess proximal to the surface of the patient's teeth is substantially “U” shaped. In some embodiments, the face of the Recess proximal to the surface of the patient's teeth is substantially “D” shaped.

In some embodiments, the approximate shape of the Recess is substantially conical. In some embodiments, the approximate shape of the Recess is substantially frusto conical. In some embodiments, the approximate shape of the Recess is substantially pyramidal. In some embodiments, the approximate shape of the Recess is substantially frusto pyramidal. In some embodiments, the approximate shape of the Recess is substantially square pyramidal. In some embodiments, the approximate shape of the Recess is substantially frusto square pyramidal. In some embodiments, the approximate shape of the Recess is substantially triangular pyramidal. In some embodiments, the approximate shape of the Recess is substantially frusto triangular pyramidal. In some embodiments, the approximate shape of the Recess is substantially square cubic. In some embodiments, the approximate shape of the Recess is substantially rectangular cubic. In some embodiments, the approximate shape of the Recess is substantially spherical. In some embodiments, the approximate shape of the Recess is substantially semi spherical. In some embodiments, the approximate shape of the Recess is substantially hemispherical. In some embodiments, the approximate shape of the Recess is substantially cylindrical. In some embodiments, the approximate shape of the Recess is substantially frusto cylindrical. In some embodiments, the approximate shape of the Recess is substantially semi cylindrical. In some embodiments, the approximate shape of the Recess is substantially hemi cylindrical. In some embodiments, the approximate shape of the Recess is substantially ellipsoidal. In some embodiments, the approximate shape of the Recess is substantially semi ellipsoidal. In some embodiments, the approximate shape of the Recess is substantially paraboloidal. In some embodiments, the approximate shape of the Recess is substantially semi paraboloidal. In some embodiments, the approximate shape of the Recess is substantially parabolic hyperboloidal. In some embodiments, the approximate shape of the Recess is substantially semi parabolic hyperboloidal. In some embodiments, the approximate shape of the Recess is substantially hemi parabolic hyperboloidal.

In some embodiments, the shape of a recess in the altered model is substantially similar to the desired shape of the Variable Depth Technology Wedge. In some embodiments, the shape of a recess in the altered model is approximately the same as the desired shape of the Variable Depth Technology Wedge. In some embodiments, the shape of a recess in the altered model substantially conforms to the desired shape of the Variable Depth Technology Wedge.

Another aspect of the present invention is that the aligner and/or the aligner with Variable Depth Technology wedge combination is cast using the model of the patient's teeth as a mold. In some embodiments, the aligner is cast using a substantially unaltered model as a mold. In some embodiments, the aligner is cast using an altered model as a mold. In some embodiments, the aligner and Variable Depth Technology Wedge combination is cast using an altered model comprising a recess as a mold. In some embodiments, the Variable Depth Technology Wedge is cast using the recess as a mold. In still other embodiments, the aligner and Variable Depth Technology Wedge are cast as a single unit from an altered model such that the approximate shape of a Variable Depth Technology Wedge substantially conforms to the approximate shape of a recess.

In some embodiments, the aligner is cast using an altered model comprising a supplemental blank as a mold. In some embodiments, the aligner is cast using an altered model comprising a supplemental blank as a mold such that the aligner comprises a movement volume. In some embodiments, the aligner is cast using an altered model comprising a supplemental blank as a mold such that the aligner comprises a movement volume substantially conforming to the approximate shape of the supplemental blank. In some embodiments, the aligner is cast using an altered model comprising a supplemental blank as a mold such that the aligner comprises a movement volume such that the movement volume approximately defines the targeted final position of a misaligned tooth. In some embodiments, the aligner is cast using an altered model comprising a supplemental blank as a mold such that the aligner comprises a movement volume such that the movement volume approximately defines the targeted final position of a misaligned tooth plus a volume between the position of the misaligned tooth and the targeted final position of the tooth.

Another aspect of the invention is a Contour Attachment. In some embodiments, the Contour Attachment applied directly to a patient's tooth. In some embodiments, the Contour Attachment is affixed to the lingual aspect of a tooth. In other embodiments, the Contour Attachment is affixed to the buccal aspect of a tooth. In some embodiments the Contour Attachment can make contact with the aligner. In some embodiments, the Contour Attachment can make contact with the Variable Depth Technology Wedge. In still other embodiments, the Contour Attachment can make contact with both the aligner and Variable Depth Technology Wedge.

In some embodiments, the Contour Attachment can promote first degree movement of a tooth. In some embodiments, the Contour Attachment can promote second degree movement of a tooth. In still other embodiments, the Contour Attachment can work in concert with the Variable Depth Technology wedge to promote second degree movement of a tooth.

In some embodiments, the Contour Attachment comprises a hardening liquid. In other embodiments, the Contour Attachment comprises a hardening semi-solid. In other embodiments, the Contour Attachment comprises a hardening gel. In other embodiments, the Contour Attachment comprises a solid. In some embodiments, the Contour Attachment can be polished away from the surface of a tooth.

In some embodiments, the Contour Attachment is applied to a surface of a tooth as a dollop. In other embodiments the Contour Attachment is applied as a lump. In other embodiments, the Contour Attachment is applied in the desired final shape. In some embodiments, the Contour Attachment is substantially hollowed out. In some embodiments, the Contour Attachment is substantially hollowed out using a tool. In some embodiments, the substantially hollowed out Contour Attachment forms the perimeter of a substantially polygonal shape.

In some embodiments, the Contour Attachment has a perimeter. In other embodiments, the Contour Attachment comprises an approximately linear ridge or berm-like formation. In other embodiments, the Contour Attachment comprises a substantially non-linear ridge or berm-like formation. In some embodiments, the perimeter of the Contour Attachment is substantially polygonal. In other embodiments, the approximate shape of the perimeter of the Contour Attachment is substantially polygonal. In some embodiments, the approximate shape of the Contour Attachment is substantially elliptical. In some embodiments, the approximate shape of the Contour Attachment is substantially square. In some embodiments, the approximate shape of the Contour Attachment is a ramp. In other embodiments, the approximate shape of the Contour Attachment is a saucer.

In some embodiments, the shape of the Contour Attachment substantially correlates with the shape of the Variable Depth Technology Wedge. In some embodiments, the Contour Attachment and Variable Depth Technology Wedge communicate in a manner substantially similar to a post-style snap. In some embodiments, the Contour Attachment provides a surface against which the Variable Depth Technology Wedge applies force.

In some embodiments, the Contour Attachment comprises a substantially uniform thickness. In other embodiments, the Contour Attachment comprises a substantially non-uniform thickness. In some embodiments, the perimeter of a Contour Attachment is substantially thicker than the interior of a Contour Attachment. In some embodiments, the thickness of the interior of a Contour Attachment is substantially zero. In some embodiments, the thickness of the interior of a Contour Attachment is approximately zero. In some embodiments, the thickness of the perimeter of a Contour Attachment is substantially uniform. In other embodiments, the thickness of the perimeter of a Contour Attachment is substantially non-uniform.

In some embodiments, the Contour Attachment is substantially transparent. In other embodiments, the Contour Attachment is approximately white. In some embodiments, the Contour Attachment is substantially translucent. In some embodiments, the Contour Attachment is substantially opaque.

Another aspect of the present invention is that the orthodontic or cosmetic movement of teeth can be substantially completed using a single appliance. In some embodiments, the single appliance comprises the aligner. In other embodiments, the single appliance comprises the aligner and Variable Depth Technology Wedge combination. In some embodiments the treatment period is longer than about six months. In some embodiments, the treatment period is about six months. In other embodiments, the treatment period is less than about six months. In other embodiments, the treatment period is about 90 days. In other embodiments the treatment period is less that about 90 days. In some embodiments, the treatment period is about 30 days. In other embodiments, the treatment period is less than about 30 days.

In some embodiments, an aligner is adjusted during the treatment period. In some embodiments, a Variable Depth Technology Wedge is adjusted during the treatment period. In some embodiments a Variable Depth Technology Wedge is replaced during the treatment period. In some embodiments, a Variable Depth Technology Wedge is adjusted during the treatment period using a crimping tool. In some embodiments, a Contour Attachment is adjusted during the treatment period. In some embodiments, a Contour Attachment is replaced during the treatment period.

For purposes of summarizing the invention, certain aspects, advantages, and novel features of the invention have been described herein. It is to be understood that not necessarily all such advantages can be achieved in accordance with any particular embodiment of the invention. Thus, the invention can be embodied or carried out in a manner that achieves or optimizes one advantage or group of advantages as taught herein without necessarily achieving other advantages as can be taught or suggested herein.

While certain aspects and embodiments of the invention have been described, these have been presented by way of example only, and are not intended to limit the scope of the invention. Indeed, the novel methods and systems described herein can be embodied in a variety of other forms without departing from the spirit thereof. The accompanying claims and their equivalents are intended to cover such forms or modifications as would fall within the scope and spirit of the invention.

What is claimed is:

1. An orthodontic system, comprising:
a body configured to cover substantially at least two adjacent teeth in a person's mouth;
wherein said body comprises a wedge configured to contact a first surface of a first tooth of said at least two teeth and exert a force on said first tooth in a first direction;
wherein said body, when positioned in the mouth, defines a first bounding surface of a movement volume into which said first tooth is permitted to move substantially in said first direction in response to said force; and
wherein a second surface of said first tooth defines a second bounding surface of said movement volume, when said body is positioned in the mouth.

2. The orthodontic system of claim 1, wherein said first surface of said first tooth is opposite said second surface of said first tooth.

3. The orthodontic system of claim 1, further comprising a contour attachment configured to attach to said first surface of said first tooth and contact said wedge.

4. The orthodontic system of claim 3, wherein said contour attachment engages said wedge to promote or alter at least one of rotation, angulation, intrusion, extrusion, translation, inclination, and tipping of said first tooth.

5. The orthodontic system of claim 1, wherein said first and second surfaces of said first tooth are substantially the same surface.

6. An orthodontic system, comprising:
a body configured to cover substantially at least two adjacent teeth in a person's mouth;
a contour attachment configured to (1) be attached to a first surface of a first tooth of said at least two teeth, and (2) contact a surface of said body;
wherein said body, when positioned in the mouth, defines a first bounding surface of a movement volume into which said first tooth is permitted to move in response to a force transmitted from said body through said contour attachment; and
wherein a second surface of said first tooth defines a second bounding surface of said movement volume, when said body is positioned in the mouth.

7. The system of claim 6, wherein said body further comprises a wedge that transmits said force to said first tooth through said contour attachment; and
wherein a surface of said wedge comprises said surface of said body.

8. The orthodontic system of claim 7, wherein said wedge is attachable to a remainder of said body.

9. The orthodontic system of claim 7, wherein said contour attachment engages said wedge to promote or alter at least one of rotation, angulation, intrusion, extrusion, translation, inclination, and tipping of said first tooth.

10. An orthodontic system, comprising:
a body configured to cover substantially at least two adjacent teeth in a person's mouth;
a contour attachment configured to be attached to a surface of a first tooth of said at least two teeth; and
wherein said body comprises a wedge configured to contact said contour attachment and exert a force on said first tooth through said contour attachment when said body is positioned in the mouth.

11. The orthodontic system of claim 10, wherein said contour attachment engages said wedge to promote or alter at least one of rotation, angulation, intrusion, extrusion, translation, inclination, and tipping of said first tooth.
